(19) United States
(12) Patent Application Publication
(10) Pub. No.: US 2007/0223869 A1
(43) Pub. Date: Sep. 27, 2007

(54) Lighting device for medical instruments

(75) Inventor: Regina Margarete Clara Kirchner, Markgroningen (DE)

Correspondence Address: Friedrich Kueffner, Suite 910, 317 Madison Avenue, New York, NY, 10017, US

(73) Assignee: Kirchner & Wilhelm GmbH & Co. KG

(21) Appl. No.: 11/726,298

(22) Filed: Mar. 21, 2007

(30) Foreign Application Priority Data
Mar. 22, 2006 (DE) 20 2006 004 508.2

(51) Int. Cl. G02B 6/00

(52) U.S. Cl. 385/141; 385/123; 385/147

(57) ABSTRACT

A lighting device for medical instruments, particularly otoscopes, in which light is transmitted from a light source through a light conductor to a light exit, wherein the light conductor is of acrylic. The light conductor may be manufactured from PMMA granulate. The light conductor may be constructed as an injection molded part

### BACKGROUND OF THE INVENTION

1. Field of the Invention

The present invention relates to a lighting device for medical instruments, particularly, otoscopes.

2. Description of the Related Art

In a lighting device for medical instruments, the light is conducted from a light source through a light conductor to the light exit. In conventional otoscopes of this type, the otoscope may have an external funnel into which the inner funnel is pushed. The light conductor is arranged between the inner and outer funnels.

In conventional instruments, a light conductor of the above-described type is manufactured from glass fibers. Very thin individual fibers having a diameter of 50 μm are used, wherein the fibers are bundled in the longitudinal direction. The individual fibers are then glued together. After the adhesive has cured, the fiber strand obtained by gluing is supported over the correct length and is provided with the desired shape and the strand is then temperature-hardened in a furnace. Subsequently, the ends of the strand, which serve as light entry surface and light exit surface, are polished and lapped.

It can be seen that the above-described manufacture of a light conductor is very cumbersome and complicated. During the manufacture, a large number of individual steps have to be carried out and also each individual step is time consuming. Moreover, in the case of glass fibers there is frequently the problem that individual fibers in a strand are damaged and the damaged fibers then constitute an obstacle for the light transmission, so that the degree of efficiency of light transmission is reduced. Also, the glued connections between the fibers may rupture.

### SUMMARY OF THE INVENTION

Therefore, it an object of the present invention to provide a lighting device for medical instruments, particularly otoscopes, and a light conductor for such a lighting device, wherein the light conductor is easily manufactured and constructed so as to be trouble-free.

In accordance with the present invention, the above object is met by manufacturing the light conductor of acrylic.

In accordance with a preferred feature, the light conductor is manufactured of PMMA granulate. This material is similar to previously used glass fibers with respect to a required transmission of light from a light entry surface to a light exit surface.

After the required shape of the light conductor has been determined, an injection tool for an injection molding process has to be prepared for manufacturing the light conductors. Consequently, when acrylic is used for making the light conductor, the method for manufacturing the light conductor is simpler and less time consuming and cost intensive once the injection molding tool has been prepared as compared to the use of glass fibers.

Since the light conductor of acrylic is compact and constructed in one piece, it is mechanically more stable than a light conductor of individual glass fibers. Individual fibers cannot be damaged. The glued connections between fibers cannot rupture.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a cross sectional view of a conventional otoscope head with a light conductor of glass fibers; and

FIG. 2 is an elevational view of a light conductor for a lighting device according to the invention.

### DETAILED DESCRIPTION OF THE INVENTION

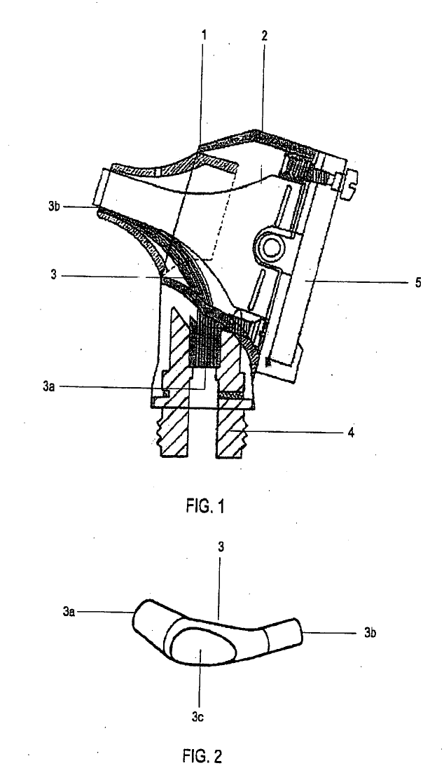

Referring to FIG. 1 of the drawing, an otoscope head in which the light conductor is manufactured of glass fibers will first be described generally.

The otoscope head includes an outer funnel 1 into which an inner funnel 2 is inserted. A light conductor 3 is arranged between the outer funnel 1 and the inner funnel 2. The light conductor 3 is illustrated in the drawing as being composed of individual glass fibers. Its light entry surface 3a is provided at a connecting piece 4 which is connected to a light source, not shown. The light conductor 3 extends between the outer funnel 1 and the inner funnel 2 up to the ends of the funnels 1 and 2 in a light exit surface 3b. The funnels 1 and 2 widen toward their other ends. At these other ends, for example, a lens 5 is provided as the optical element.

In accordance with the present invention, the otoscope head is constructed in the same manner as described and illustrated in FIG. 1, with the exception that the light conductor 3 of glass fibers is replaced by a light conductor 3 of acrylic.

Such a light conductor 3 of acrylic is illustrated in FIG. 2. The light conductor 3 is preferably manufactured of PMMA granulate with material properties with respect to light transmission similar to those of glass fibers. The light conductor is constructed as an injection molded part and has a light entry surface 3a and a light exit surface 3b. By manufacturing the light conductor 3 as an injection molded part, the desired shapes can be manufactured easily. For example, by appropriately constructing the injection molding tool, it is easily possible to provide a recess 3c at the light conductor 3 which may be required for mounting the light conductor 3 between the outer funnel 1 and the inner funnel 2. The light conductor 3 illustrated in FIG. 2 of acrylic is mechanically stable and less susceptible to trouble as compared to a light conductor if glass fibers.

The lighting device of the present invention includes a light conductor of acrylic which can be manufactured easily, quickly and inexpensively and which additionally is less susceptible to trouble as compared to a conventional light conductor of glass fibers.

While specific embodiments of the invention have been shown and described in detail to illustrate the inventive principles, it will be understood that the invention may be embodied otherwise without departing from such principles.

I claim:

1. A lighting device for medical instruments, the lighting device comprising a light source and a light conductor for transmitting light from the light source to a light exit, wherein the light conductor is of acrylic.

2. The lighting device for medical instruments according to claim 1, wherein the light conductor is manufactured of PMMA granulate.

3. The lighting device according to claim 1, wherein the light conductor is an injection molded part.

4. The lighting device for a medical instrument, wherein the medical instrument is an otoscope.
